(19) United States
(12) Patent Application Publication
(10) Pub. No.: US 2011/0160874 A1
(43) Pub. Date: Jun. 30, 2011

(54) Control Device and Method for Controlling a Device Connected to an Energy Supply

(75) Inventors: Christian Schulze, Lehrte (DE); Martin Herzog, Lahstedt/Gadenstedt (DE)

(73) Assignee: ROBERT BOSCH GMBH, Stuggart (DE)

(21) Appl. No.: 12/737,385

(22) PCT Filed: May 26, 2009
(86) PCT No.: PCT/EP2009/056342

§ 371 Date: Mar. 17, 2011

(30) Foreign Application Priority Data
Jul. 9, 2008 (DE) 102008040272.9

(51) Int. Cl. G05B 11/01

(52) U.S. Cl. 700/12

(57) ABSTRACT

A control device for an electric device has an interface to an administrative unit and an interface to a switch for the activation and deactivation of the electric device, the control device activating or deactivating the electric device via the switch as a function of information about an energy supply transmitted by the administrative unit.

### BACKGROUND OF THE INVENTION

1. Field of the Invention

The present invention relates to a control device and a method for controlling a device connected to an energy supply.

2. Description of the Related Art

An automatic watering system, which is operated with the aid of a solar energy supply, is already known from the published Japanese patent application document JP 2000-270696 abstract. An energy store is charged via a solar cell. The operation of the watering device is initiated upon the detection of sunrise.

### BRIEF SUMMARY OF THE INVENTION

In contrast, the control device according to the present invention has the advantage that an administrative unit of an energy supply system on the one hand and a control device for activating a device or for deactivating the device may be disposed at physically separate locations, the device being activated as a function of information about an energy supply. Thus, it is possible to trigger even a multitude of devices at physically different locations via the administrative unit and to supply these devices with information about the energy supply, possibly also sequentially or according to a predefined time schedule, so that, for example, different devices are able to be operated one after the other in order to ensure the most uniform base load possible on the one hand, and to avoid peak loads on the other. With the aid of the closed-loop control ensured via the control device and the connection of the control device to the administrative unit, it is therefore possible for the energy supply system to influence the operation of the device in a selective manner, so that the available output and the requested output may be mutually adapted.

Furthermore, according to the method of the present invention for controlling a device connected to an energy-supply system, it is also advantageous that the energy requirement is transmitted from the device to the administrative unit, so that a corresponding adaptation of the supplied energy is also able to be ensured by the administrative unit, possibly also at a suitable moment. If the device requests a quantity of energy, then the device is able to be activated via the administrative unit and the control device as soon as this quantity of energy is available in a suitable form or at a suitable instant. Overall, this enables a simple operation of energy consumers at a time, for example, when a sufficient quantity of regenerative energy such as solar energy or wind energy is available from an energy supply unit. Furthermore, in the case of energy consumers for which the precise timing of the operation is not critical, it is additionally possible to avoid activation during times of peak usage.

It is advantageous to transmit a data protocol for the transmission of a starting time or a time duration of an energy supply and/or an energy requirement. In particular, this makes it possible for the device to notify the supply unit of the time by which a device must be supplied with energy under any circumstances, so that its functionality will not be put at risk or a consumer request cannot be satisfied.

Thus, even in the event that no suitable instant is available for an especially advantageous energy withdrawal, the device will be able to be operated in the desired manner nevertheless. Moreover, a suitable adaptation to changing peaks or supply situations as they may occur in particular when regenerative energy sources are involved is possible as well in this way, without any disadvantageous consequences for a user.

The control device is able to exchange information with the administrative unit in an especially uncomplicated manner via the connection to the energy supply system. Additional means for the transmission of information between the administrative unit and the control device may be dispensed with.

Furthermore, it is advantageous to provide an operating unit, via which a supplied energy type or a message about the energy requirement is selectable. For example, through an input via the operating unit, a user may request that a device connected to a current supply be operated only if sufficient energy is available from a solar energy generator. Furthermore, it is also possible that the cost of the energy supply depends on the energy supply. Pertinent information about the current cost of energy may be provided by the administrative unit. A limit price for energy is specifiable via the operating unit, so that the device is switched on only if this limit price is met or undercut.

Furthermore, the control device advantageously also has a memory for storing an identification code, which is transmitted to the administrative unit if required. This makes it possible for the device to identify itself to the administrative unit. For example, in this manner an accounting of the energy consumption may take place via the administrative unit, according to the energy requested by the device, the timing of the request, or on the basis of other parameters. In addition, it is possible that the administrative unit has information available for individual devices about priorities of these devices, and thus may transmit to the appropriate devices an energy supply in line with the predefined priorities. This enables a priority-based supply of energy, such that, for example, devices whose operating time is critical may be signaled an energy supply earlier than other devices, once a corresponding supply of energy is available. For instance, these devices may be switched on earlier than other devices, for which a corresponding activation may also take place at a later point in time.

Analogously, it is also possible to deactivate a device when corresponding energy is no longer able to be supplied at that moment, for instance when the instantaneous generation of regenerative energy is no longer sufficient for the overall supply of the devices connected to the energy supply network and provided for this purpose.

### BRIEF DESCRIPTION OF THE DRAWINGS

FIG. 1 shows an energy supply system having two devices according to the present invention, which are connected to the energy supply system, as well as an administrative unit.

FIG. 2 shows a device having a control device according to the present invention.

FIG. 3 shows an exemplary embodiment for a method sequence according to the present invention.

### DETAILED DESCRIPTION OF THE INVENTION

The control device according to the present invention may be used for a variety of devices that are connected to energy supply systems of different types. These devices may be hot water supply systems, gas supply systems or other supply systems, in which an energy carrier in gaseous or liquid form is supplied to a device. In particular, however, it is advantageous to use a control device according to the present invention for devices that are connected to an energy supply network implemented the form of a power supply system. Since the buffer-storage of electrical energy is especially costly and entails losses or is possible only to a limited extent, adapting a device operation to an energy supply allows both the generation of current and the utilization of current to take place in an especially efficient manner. Therefore, the present invention will be elucidated in the following text using as an example a device which is equipped with a control device according to the present invention and connected to an energy supply system in the form of a power supply system.

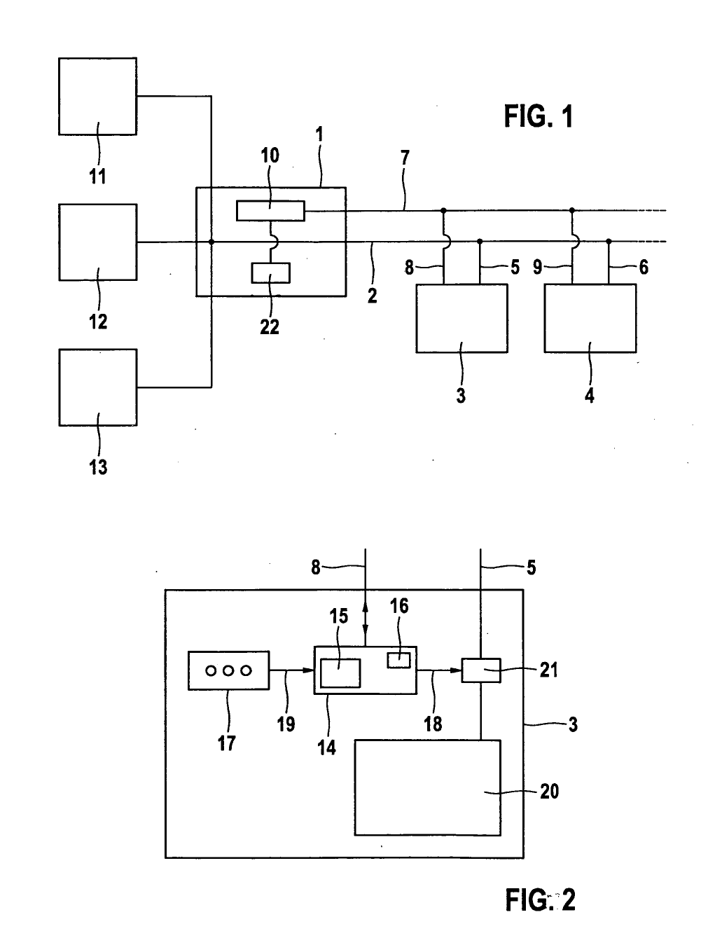

FIG. 1 shows an administrative unit 1, which administers a power supply system 2 to which a first device 3 and a second device 4 are connected. On the one hand, power supply system 2 may be a household power supply system, which supplies devices with electrical energy in a local environment. However, it is also possible to place the administrative unit in a distributor station of a power supply plant and possibly dispose devices 3, 4 also in different buildings and at different connection terminals of a power supply system which, for example, supplies a particular urban district. Devices 3, 4 have connections 5, 6, via which they are connected to power supply system 2.

Administrative unit 1 is able to access different energy generation units 11, 12. For instance, first energy generation unit 11 is implemented as a photovoltaic system. Second energy generation unit 12 is realized as a wind-power plant, for example. Third energy-generation unit 13 is implemented as garbage incinerator power plant, for instance.

Administrative unit 1 has a processing unit 10, which transmits information about an energy supply at least to the two devices 3, 4 connected to power supply system 2 as a function of the power drawn by energy-generation units 11, 12, 13 and/or the power drawn via energy-supply system 2, possibly also via other consumers not shown in the figure.

Corresponding information may then be transmitted also to other devices (not shown in the figure) which are connected to energy supply system 2 in addition. Furthermore, it is also possible that additional devices to which no information about an energy supply is transmitted or is able to be transmitted are connected to power supply system 2.

In one first specific development, an additional data connection 7 is provided, via which information about an energy supply is transmitted to connections 8, 9 of devices 3, 4. Additional data connection 7 may be realized as a telephone connection, for example, or as a data network connection such as a data network, e.g., the Internet. In one further development, it is also possible to use the lines of power supply network 2 for transmitting the information about an energy supply.

The method of functioning of a control device according to the present invention is illustrated with the aid of FIG. 2. FIG. 2 shows device 3 in detail. Device 3 has one consumer 20. Consumer 20 utilizes the transmitted electrical energy and is implemented as a washing machine, an electrical storage heater or as a chest freezer, for example. Other electrical devices are conceivable as well. It is especially advantageous to provide as consumer 20 devices for which power must be withdrawn from power supply 2 on a regular basis, but where the exact time of this power consumption is not necessarily critical.

An electrical switching unit 21, which is controlled by a control device 14 according to the present invention, is provided between consumer 20 and connection 5 to the power supply system. Control device 14 controls electrical switching unit 21 via an interface 18 and is able to release or block the energy supply from connection 5 to power supply system 2 to electrical consumer 20 via the control of switch 21, so that consumer 20 may be activated or deactivated by controlling switch 21. For this purpose, control device 14 according to the present invention is equipped with a processing unit 15, which processes signals that are made available by administrative unit 1 via data input 8. If an energy supply is signaled to control device 14, then control device 14 activates consumer 20 by controlling switch 21, so that device 3 is automatically able to be activated without a consumer having to carry out another, separate activation.

In one further specific development, it is also possible for data interface 8 to be implemented bidirectionally and a request for the supply of energy be transmitted from control device 14 to administrative unit 1 via data interface 8. Administrative unit 1 now knows that a device has requested the supply of energy and may then notify this device via data interface 8 of the supply of energy at a suitable instant.

In one specific development, control device 14 includes a memory unit 16, which stores an unambiguous identification code of electrical device 3 or control device 14. If this identification code is transmitted to administrative unit 1, then it is possible, for example, to determine the particular power consumption of electrical device 3 or consumer 20, so that this may be taken into account in the information about an energy supply. Furthermore, instead of notifying a multitude of devices connected to power supply system 2, it is possible to address electrical device 3 in a selective manner via the unambiguous identification information.

Furthermore, it is advantageous to connect control device 14 via an interface 19 to an operating unit 17. With the aid of, operating unit 17, for example, it is possible to preselect a time by which an operation of the electrical device should have taken place for a specific period of time. As an example, it may be specified to supply an electrical storage heater with electrical energy for at least two hours by 7 o'clock the next morning. If this input takes place the previous evening at 6 o'clock, for instance, then administrative unit 1 is able to select a suitable instant for the supply of energy during the night. An activation must take place no later than 5 o'clock in the morning, however, in order to allow an activation of the storage heater for the desired minimum period of time. The administrative unit can then select either a time period during the night during which a low power consumption of consumers is to be expected, for instance, or during which an especially high portion of available energy is provided by, or is to be expected from, wind-generation unit 12, for example.

In another specific embodiment, it is also possible to use operating unit 17 for preselecting an energy supply of a desired energy type. For example, it may be preselected that an activation of a device, e.g., a washing machine, should take place only when sufficient electrical energy from a solar power generation is available via solar energy generation unit 11. A corresponding input of a desired type of energy may be transmitted from control device 14 to administrative unit 1 via data interface 8. Administrative unit 1 checks when a sufficient energy contribution by solar energy generation unit 11 is available and then initiates via corresponding energy supply information to control unit 14, so that an activation of consumer 20, e.g., a washing machine, is able to take place.

In another specific development it is also possible to provide an energy price limit via operating unit 17. In the event that the energy price is variable and depends on the power consumption of all participants, for example, or on the supply quota of natural energy resources, especially via solar energy generation unit 11 or wind energy generation unit 12, then corresponding price information about the current cost of energy is able to be transmitted from administrative unit 1 to devices 3, 4 connected to the power supply system. The device will then be activated when the price is lower than the price specified by operating unit 17.

In a first specific development, administrative unit 1 analyzes the energy quantity supplied by individual energy supply units 11, 12, 13. In one preferred specific embodiment, a breakdown according to the provided types of energy may be provided in addition. Apart from the currently supplied energy, in one additional specific embodiment it is also possible to use a prediction for the supply of solar energy or wind energy, such as the weather situation. Furthermore, information about the consumers may be taken into account. This could be distribution patterns of peak loads across a typical course of a day. Corresponding information is processed by processing unit 10 of administrative unit 1. If sufficient energy is available, then information about an energy supply may be transmitted for types of devices that typically do not require a specific activation instant, such as so-called night storage heaters, for example. However, in an additional specific development it is also possible that administrative unit has information available in a memory device 22 about the specific devices that are connected to power supply system 2. An activation may then take place in a selective manner by transmitting information to the corresponding device. Moreover, it is also possible to buffer-store information about a request for an energy supply in memory 22, so that devices are able to be activated individually either according to an input of a temporal sequence or according to some other type of priority sequence.

In the event that rising consumption is detected and/or that an energy supply from energy supply units 11, 12 and/or 13 is dropping, in one further specific development it is also possible for administrative unit 1 to deactivate devices connected to power supply system 2. In this way it can be prevented, for instance, that a cooling operation of a cooling device is initiated or continued at an instant when especially high consumption occurs, if the corresponding cooling operation may also take place a short while later, e.g., 30 minutes later.

In another specific development, instead of connecting to power supply system 2 a device that consumes power, a user may also connect a system that supplies energy to the power supply system, such as a home photovoltaic system, for example. In this case, the device may be treated like an energy supply unit.

In the decision of the administrative unit to supply energy, information about the location of the energy generation and the location of the energy consumption may be considered as well. This makes it possible, for example, to switch energy consumers and energy generation units in such a way that the path between the energy generation unit and the location of the energy consumption is kept as short as possible. Losses that arise in an energy transfer are able to be taken into account in this manner. In the specific development of a power supply system, apart from considering the spatial distance, the number of times the voltage must be transformed between the location of the energy generator and the energy consumption unit may be taken into account, since especially high losses occur during the transformation, in particular. Moreover, weighting may be implemented for the voltage at which energy is transported along the path since the line losses in the high-voltage range are lower than in a low-voltage transmission. In addition to a temporal adaptation, a spatial adaptation is thus able to take place as well. In memory 22, the locations of the energy consumption are preferably assigned to the individual identification codes of the devices connected to power supply system 2.

In order to facilitate the transmission of information between the administrative device and the control devices of the units connected to the power supply system, a uniform data protocol is preferably set up, in which an entry is made at the different locations of a data set as to the time when electrical power is requested, the length of time for which power is requested and, if appropriate, the likely scope of the overall power consumption. Additional information may be incorporated into the protocol in the individual case. With the aid of a correspondingly standardized data protocol, an especially efficient and reliable transmission of the pertinent data is possible. In the event that additional information such as information about a type of energy or a desired price is added at a later point in time, this data may be appended to the already existing data set. Corresponding information about the priority of an energy consumer may be transmitted via the data protocol as well. In this way it can be prevented, for instance, that especially important energy consumers, or energy consumers whose operation happens to be at a critical stage just then, are switched off. When operating a washing machine, for instance, it may be ensured that, once the washing machine has been activated, the corresponding laundry program is able to be run through completely even if an energy supply is no longer is available in sufficient quantity at a later point in time, and that the device will not be deactivated. On the other hand, in the case of a storage heater, it would be possible to interrupt a two-hour heating operation after one hour already, for instance, without any detrimental effect on a user.

In addition to the exemplarily cited energy supply units, i.e., solar energy, wind energy or fuel combustion, it is also possible to include other types of energy producers such as nuclear power plants or hydroelectric power plans, as power supply systems.

Moreover, a plurality of administrative units in the power supply system may be set up in a decentralized manner, or corresponding administrative units may be available only at central nodes or switching points of a power supply system.

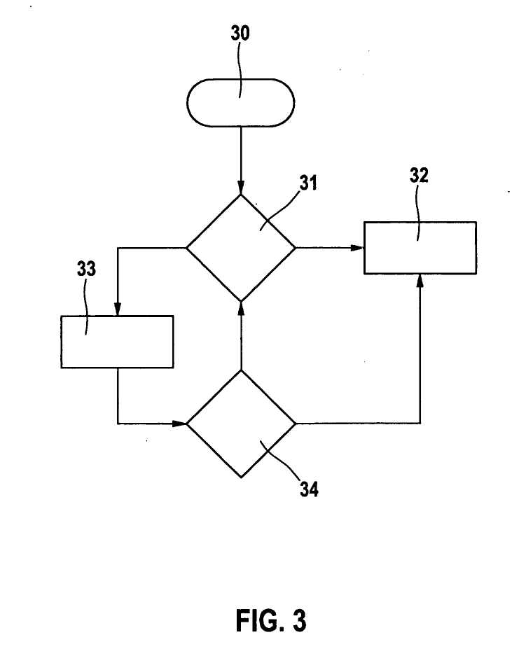

FIG. 3 shows a method sequence according to the present invention. The method is started based on an initial step 30 initiated by a user, such as the activation of an electrical consumer. In a first check step 31, the control device queries whether corresponding positive energy supply information from administrative unit 1 has been received. In such a case, branching to an operational step 32 takes place, in which the device connected to the power supply system is operated. In all other cases, branching to a query step 33 is implemented, in which control device 14 requests an energy requirement from administrative unit 1. In a second check step 34, it is checked whether a user wishes to operate the device even in the absence of express information about an energy supply. The user can ensure this, for example, by a time input or by some other appropriate input such as pressing a key for overriding energy supply information of administrative unit 1. If a corresponding override is present, then branching to operational step 32 will take place as well. If no corresponding override is present, then a return to first check step 31 occurs and it is waited for the transmission of corresponding energy supply information from administrative unit 1, so that the device may be switched on in this case.

1-10. (canceled)

11. A control device for an electric device, comprising:
an interface to an administrative unit; and
an interface to a switch for activating and deactivating the electric device, the control device activating or deactivating the electric device via the switch as a function of information about an energy supply transmitted by the administrative unit.

12. The control device as recited in claim 11, wherein the control device is connected to the administrative unit for the transmission of information regarding an instantaneous energy requirement of the electric device to the administrative unit.

13. The control device as recited in claim 12, wherein a data protocol for the transmission of information regarding at least one of (i) a temporal start, (ii) a duration of an energy supply, and (iii) an energy requirement is provided between the control device and the administrative unit.

14. The control device as recited in claim 13, wherein the control device has a connection to an energy supply system, and wherein a transmission of information regarding one of an energy supply or an energy requirement takes place via the connection to the energy supply system.

15. The control device as recited in claim 14, further comprising:
an interface to an operating unit for one of (i) selecting a provided energy or (ii) notifying the administrative unit of an energy requirement.

16. The control device as recited in claim 14, further comprising:
a memory for storing an identification code of the electric device, wherein the identification code is transmitted to the administrative unit.

17. A method for controlling an electric device connected to an energy supply system, comprising:
transmitting information regarding at least one of an energy requirement and an energy supply between an administrative unit of the energy supply system and the electric device connected to the energy supply system; and
one of activating or deactivating the electric device by the administrative unit as a function of at least one of the energy available via the energy supply system and the energy requirement of the electric device.

18. The method as recited in claim 17, wherein at least one of a start and a duration of at least one of an energy supply and an energy requirement is transmitted between the administrative unit and the electric device.

19. The method as recited in claim 18, wherein information about at least one of a desired type of energy and a supplied type of energy is transmitted between the administrative unit and the electric device.

20. The method as recited in claim 18, wherein a data transmission takes place between the administrative unit and the electric device via the energy supply system.
